(19) United States
(12) Patent Application Publication
(10) Pub. No.: US 2014/0030534 A1
(43) Pub. Date: Jan. 30, 2014

(54) CELLULOSIC MATERIAL PRESERVATIVES CONTAINING DISACCHARIDE

(71) Applicants: William B. Carlson, Seattle, WA (US); Gregory D. Phelan, Cortland, NY (US)

(72) Inventors: William B. Carlson, Seattle, WA (US); Gregory D. Phelan, Cortland, NY (US)

(73) Assignee: Empire Technology Development LLC

(21) Appl. No.: 13/990,744

(22) PCT Filed: Jul. 24, 2012
(86) PCT No.: PCT/US12/47983

§ 371 Date: May 30, 2013

(51) Int. Cl. C09D 5/14; B27K 3/50

(52) U.S. Cl. CPC C09D 5/14; B27K 3/50
USPC 428/479.6; 523/122; 428/535; 428/541; 428/514

(57) ABSTRACT

Articles containing a cellulosic material and at least one polymer containing at least one antimicrobial disaccharide are described, as well as methods for their preparation and use.

### BACKGROUND

The following description is provided to assist the understanding of the reader. None of the information provided or references cited is admitted to be prior art.

Glucose, a sugar, is polymerized into poly(1,4-β-glucose) or cellulose, an important chemical component of wood or other cellulosic materials. Thus, a significant portion of wood is sugar, which can provide energy for a wide variety of life, both microorganisms and animals. Such animals and microorganisms (e.g., fungi) feed on wood, leading to its decay. When wood is used as a structural material, an organism feeding on wood and the resulting decay is undesirable.

Preservatives have long been used to maintain integrity of the wood. Conventional wood preservation chemicals are biocidally effective but contain high levels of heavy metals and other toxic chemicals, many of which pose significant health and environmental concerns.

### SUMMARY

In accordance with one aspect, the present technology provides an article including a cellulosic material and at least one polymer including at least one antimicrobial disaccharide. In some embodiments, the cellulosic material may include wood, paper, or both. In some embodiments, the article is a wooden plank, utility pole, railroad tie, ship's hull, wooden utensil, toy, model, piece of furniture, vehicle, or serving dish.

In some embodiments of the articles, the polymer is a polyolefin. In some embodiments, the polymer is a polyolefin selected from the group consisting of polyacrylate, polymethacrylate, polyacrylamide, and polymethacrylamide.

In some embodiments of the article, the antimicrobial disaccharide is selected from the group consisting of sophorose, maltose, sucrose, lactulose, lactose, maltose, trehalose, cellobiose, nigerose, gentiobiulose, maltulose, isomaltose, trehalose, sophorose, laminaribiose, gentiobiose, turanose, palatinose, mannbiose, melibiose, xylobiose, melibiulose, rutinose, rutinulose, galactofuranose, streptobiosamine, or a combination of any two or more thereof. In some embodiments, the polymer comprises repeating units formed from a monomer of Formula I:

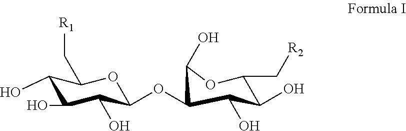

wherein:

R₁, R₂ are each independently OH or moiety that is acrylic, methacrylic, styrenyl, vinyl, vinyl thioether, vinyl ketone, vinyl ether, vinyl alcohol ester, vinyl amine, vinyl amide (e.g., acrylamide, methacrylamide), cyclobutenyl, cyclopentenyl, cyclohexyl, acrylamide, isocyanate, epoxy, oxetanyl, bicyclo[2.2.1]hept-2-enyl, DL-lactide, or a combination of any two or more thereof. In one instance wherein the moiety is a vinyl on an amine or amide, the moiety may be presented by C═C—NH2, NRH, NR2, or C═C—N—C(═O)—R. In some such embodiments, the polymer comprises repeating units formed from a mixture of mono- and di-acrylic or methacrylic monomers of Formula I. In some embodiments, the polymer comprises a cross-linked sophorose polymer network.

In some embodiments of the article, the polymer further comprises a lipid moiety. In some embodiments, the polymer further comprises an omega-3 fatty acid moiety. In some embodiments, the antimicrobial disaccharide comprises a cross-linking moiety, in some embodiments, the disaccharide comprises one or more of an acrylate, methacrylate, acrylamide or methacrylamide moiety (i.e., group). In some embodiments, the polymer is antibacterial, antifungal, or both.

In another aspect, the present technology provides a method of preserving a cellulosic material, the method including: contacting the cellulosic material with at least one polymer including at least one antimicrobial disaccharide. In some embodiments, the contacting step comprises polymerizing a plurality of monomers of Formula I as set forth herein.

Another aspect provides a method of preserving a cellulosic material, the method including: polymerizing a monomer of Formula I to make a polymer including repeat units formed from the monomer; and contacting the cellulosic material with the polymer; wherein the monomer of Formula I is as set forth herein.

In some embodiments of the methods, the polymer further comprises a lipid moiety. In other embodiments, the polymer further comprises an omega-3 fatty acid moiety. In some embodiments, the polymer farther comprises a maltose moiety. In some embodiments, the polymer further comprises a cross-linking moiety linked to the disaccharide moiety. In some embodiments, the polymer is antibacterial, antifungal, or both. In some embodiments, the cellulose material comprises wood or paper.

Another aspect of the present technology provides an article, including at least one non-natural polymer including at least one antimicrobial disaccharide with a cross-linking moiety. In some embodiments, the article includes a cellulose material that includes wood, paper, or both. In some embodiments of the article, the disaccharide is linked to the cross-linking moiety through at least one spacer. In some embodiments, the cross-linking moiety comprises styrene, vinyl ketone, urethane, ester, ether, thioether, disulfide, divinyl benzene, ethyleneglycol dimethacrylate, polyethylene glycol dimethacrylate, pentaerythritol trimethacrylate, hexamethylene dimethacrylate, neopentyl glycol dimethacrylate, ethylene diamine, diethylene triamine, polyamide, mercaptans, or a combination of any two or more thereof. In some embodiments, the spacer comprises a moiety selected from the group consisting of amine, alkylene, alkenylene, alkynylene, arylene, ether, polyether, ester, polyester, polyurea, polyurethane, lactam, polyamide, amide, thioether, phosphoryl, phosphorous, borate, boron, arsenic, haloalkylene, haloalkenylene, haloalkynylene, haloarylene and a combination of any two or more thereof. In some embodiments, the spacer comprises methylene, ethylene, ethenylene, propylene, propenylene, butylene, butenylene, pentalene, pentenylene, hexylene, hexenylene, heptalene, heptenylene, octalene, octenylene, nonalene, nonenylene, decalene, decenylene, fluoroalkylene, fluoroalkenylene, fluoroalkynylene, fluoroarylene, chloroalkylene, chloroalkenylene, chloroalkynylene, chloroarylene, bromoalkylene, bromoalkenylene, bromoalkynyiene, bromoarylene, iodoalkylene, iodoalkenylene, iodoalkynylene, iodoarylene, or a combination of any two or more thereof. In some embodiments, the article is antibacterial, antifungal or both.

The foregoing summary is illustrative only and is not intended to be in any way limiting. In addition to the illustrative aspects, embodiments and features described above, further aspects, embodiments and features will become apparent by reference to the following drawings and the detailed description.

### BRIEF DESCRIPTION OF THE DRAWINGS

FIG. 1 provides a schematic of the chemical structures of sophorose dimethacrylate and a process of making the same in an illustrative embodiment,

FIG. 2 provides a general scheme showing the derivation of an acrylamide disaccharide wood preservative from maltose in an illustrative embodiment.

FIG. 3 provides a general scheme showing the chemical structures of sophorose preservative with a fatty acid and a process of making the same in an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The technoloy is described herein using several definitions, as set forth throughout the specification.

The use of the terms “a” and “an” and “the” and similar referents in the context of describing the elements (especially in the context of the following claims) are to be construed to cover both the singular and the plural, unless otherwise indicated herein or clearly contradicted by context.

As used herein, “about” will be understood by persons of ordinary skill in the art and will vary to some extent depending upon the context in which it is used. If there are uses of the terms which are not clear to persons of ordinary skill in the art, given the context in which it is used, “about” will mean up to plus or minus 10% of the particular term e.g., ±7%, ±5%, ±4%, ±3%, ±2%, ±1%, ±0.5%, ±0.2%, +0.1%, or ±0.05%.

The term “acrylamide” refers to groups derived from H₂C═CH—C(═O)NH₂ that are part of another molecule or group. Acrylamide groups may include primary, secondary or tertiary amides N-substituted acrylamides). Acrylamide groups may be attached to a molecule or another group through the amide nitrogen (forming a secondary or tertiary amide) or through a carbon in the vinyl group.

The term “acrylic” (or “acrylate”) refers to groups derived from acrylic acid (H₂C═CH—C(═O)OH) that are part of another molecule or group. Acrylic groups may include salts or esters of acrylic acid. Acrylic groups may be attached to a molecule or another group through the carboxyl OH (forming an ester) or through a carbon in the vinyl group.

The term “alkylene” alone or as part of another substituent refers to a divalent radical of an alkyl (including cycloalkyl) group. Each alkylene may be divalent at the same carbon or different carbons. For example, the alkylene group based on ethyl is ethylene, and includes —CH(CH₃)— as well as —CH₂CH₂—. Thus, for alkylene groups, no particular pattern of attachment or orientation of the group is implied. Similarly, “ene” added to other terms such as “alkenyl,” “alkynyl,” or “aryl” (i.e., alkenylene, alkynylene, and arylene) will be understood to refer to divalent forms of alkenyl, alkynyl, and aryl groups. Alkylene, alkenylene, alkynylene and arylene groups may be substituted or unsubstituted as described herein. For example, haloalkylene groups are alkylene groups substituted with one or more halogens; haloalkenylene groups are alkenylene groups substituted with one or more halogens; and so forth.

Alkyl groups include straight chain and branched chain alkyl groups which may be substituted or unsubstituted, in some embodiments, an alkyl group has from 1 to 30 carbon atoms, from 1 to 24 carbons, from 1 to 18 carbons, from 1 to 12 carbons, from 1 to 8 carbons or, in some embodiments, such as lower alkyl, from 1 to 6, or 1, 2, 3, 4 or 5 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups.

Cycloalkyl groups are cyclic alkyl groups. In some embodiments, cycloalkyl groups have from 3 to 30 carbon atoms. In some embodiments, the cycloalkyl group has 3 to 10 or 3 to 7 ring members, whereas in other embodiments the number of ring carbon atoms range from 3 to 5, 3 to 6, or 5, 6 or 7. Cycloalkyl groups further include monocyclic, bicyclic and tricyclic ring systems. Monocyclic groups include, e.g., cyclopropyl, cyclobutyl, cyclopentyl, cyclohexyl, and cycloheptyl groups. Bicyclic and tricyclic cycloalkyl groups include bridged or fused rings, such as, but not limited to, bicyclo[3.2.1]octane, decalinyl, and the like. Cycloalkyl groups include rings that are substituted with straight or branched chain alkyl groups, in some embodiments, the cycloalkyl groups are substituted cycloalkyl groups. Representative substituted alkyl groups may be mono-substituted or substituted more than once, such as, but not limited to, mono-, di- or tri-substituted with substituents such as those listed herein.

Alkenyl groups include straight and branched chain alkyl groups as well as cycloalkyl groups as defined above, except that at least one double bond exists between two carbon atoms. In some embodiments, alkenyl groups have from 2 to 30 carbon atoms, and typically from 2 to 10 carbons or, in some embodiments, from 2 to 8, 2 to 6, or 2 to 4 carbon atoms. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, among others. In some embodiments, the alkenyl group is a cycloalkenyl group having from 4 to 8 carbons, e.g., cyclobutenyl, cyclopentenyl, cyclohexenyl, or bicyclo[2.2.1]hept-2-enyl. Representative substituted alkenyl groups may be mono-substituted or substituted more than once, such as, but not limited to, mono-, di- or tri-substituted with substituents such as those listed herein.

Alkynyl groups include straight and branched chain alkyl groups as defined above, except that at least one triple bond exists between two carbon atoms. In some embodiments, alkynyl groups have from 2 to 30 carbon atoms, and typically from 2 to 10 carbon atoms or, in some embodiments, from 2 to 8, 2 to 6, or 2 to 4 carbon atoms. Examples include, but are not limited to —C≡CH, —CH≡CCH₃, —CH₂C≡CH, —CH₂C≡CCH₃, —CH(CH₂CH₃)C≡CH, among others. Representative substituted alkynyl groups may be mono-substituted or substituted more than once, such as, but not limited to, mono-, di- or tri-substituted with substituents such as those listed herein.

Aryl groups are cyclic aromatic hydrocarbons of 6 to 14 carbons that do not contain heteroatoms. Aryl groups herein include monocyclic, bicyclic and tricyclic ring systems. Thus, aryl groups include, but are not limited to, phenyl, azulenyl, heptalenyl, biphenyl, fluorenyl, phenanthrenyl, anthracenyl, indenyl, pentalenyl, and naphthyl groups. In some embodiments, aryl groups contain from 6 to 12 or even 6 to 10 carbon atoms in the ring portions of the groups. In some embodiments, the aryl groups are phenyl or naphthyl. The phrase “aryl groups” includes groups containing fused rings, such as fused aromatic-aliphatic ring systems (e.g., indanyl, tetrahydronaphthyl, and the like). Aryl groups may be unsubstituted, monosubstituted, or substituted more than once with substituents such as those indicated herein.

Alkoxy groups are hydroxyl groups (—OH) in which the bond to the hydrogen atom is replaced by a bond to a carbon atom of an alkyl group as defined above. Examples of linear alkoxy groups include but are not limited to methoxy, ethoxy, propoxy, butoxy, pentoxy, hexoxy, and the like. Examples of branched alkoxy groups include but are not limited to isopropoxy, sec-butoxy, tert-butoxy, isopentoxy, isohexoxy, and the like. Representative substituted alkoxy groups may be substituted one or more times with substituents such as those indicated herein.

The term “acyl” refers to —C(O)R groups, where R is a substituted or unsubstituted alkyl, cycloalkyl, alkenyl, alkynyl, or aryl group as defined herein.

The term “amine” (or “amino”) as used herein refers to —NHR and —NRR′ groups, wherein R, and R′ are independently hydrogen, or a substituted or unsubstituted alkyl, alkenyl, alkynyl, cycloalkyl, or, aryl group as defined herein. Examples of amino groups include NH₂, methylamino, dimethylamino, ethylamino, diethylamino, propylamino, isopropylamino, phenylamino, benzylamino, and the like.

The term “ether” refers to —O— groups that are bonded to carbon atoms of two different organic groups.

The terms “hydroxy” and “hydroxyl” refers to —OH groups.

The term “halo” or “halogen” refers to —F, —Cl, —Br, and —I groups.

The term “isocyanate” refers to —N═C═O groups.

The term “urea” refers to mono- and divalent CO(NH₂)₂ groups.

The term “lactide” refers to groups that are the cyclic di-ester of lactic acid (CH₃CH(OH)COOH).

The term “methacrylamide” refers to groups derived from H₂C═C(CH₃)—C(═O)NH₂ that are part of another molecule or group. Methacrylamide groups may include primary, secondary or tertiary amides (i.e., N-substituted methacrylamides). Methacrylamide groups may be attached to a molecule or another group through the amide nitrogen (forming a secondary or tertiary amide) or through a carbon in the vinyl group.

The term “methacrylic” (or “methacrylate”) refers to groups derived from methacrylic acid (H₂C═C(CH₃)—C(═O)OH) that are part of another molecule or group. Methacrylic groups may include salts or esters of methacrylic acid. Methacrylic groups may be attached to a molecule or another group through the carboxyl OH (forming an ester) or through a carbon in the allyl group.

The term “polyacrylate” refers to a polymer derived from two or more acrylic acid monomers. The acrylic acid monomers may be in the form of salts and/or esters and may be the same or different (i.e., a mixture). The polyacrylate may be a copolymer with one or more other types of non-acrylic acid monomers.

The term “polymethacrylate” refers to a polymer derived from two or more methacrylic acid monomers. The methacrylic acid monomers may be in the form of salts and/or esters and may be the same or different (i.e., a mixture). The polymethacrylate may be a copolymer with one or more other types of non-methacrylic acid monomers.

The term “polyacrylamide” refers to a polymer derived from two or more acrylamide monomers. The acrylamide monomers may be primary, secondary or tertiary amides in which the side chains are selected from substituted and unsubstituted alkyl, alkenyl, aryl groups, of any other groups, such as olefin groups; in general, any side chain containing an organic, inorganic, heteroatom system, or a combination thereof, may be selected. The polyacrylamide may be a copolymer with one or more other types of non-acrylamide monomers.

The term “polymethacrylamide” refers to a polymer derived from two or more methacrylamide monomers. The acrylamide monomers may be primary, secondary or tertiary amides in which the side chains are selected from substituted and unsubstituted alkyl, alkenyl, aryl groups, of any other groups, such as olefin groups; in general, any side chain containing an organic, inorganic, heteroatom system, or a combination thereof, may be selected. The polymethacrylamide may be a copolymer with one or more other types of non-methacrylamide monomers.

The term “styrenyl” refers to a phenyl vinyl group. The styrenyl group may be attached to other moieties through the vinyl group or the phenyl group.

The term “thioether” (or “sulfide”) refers to —S— groups bonded to carbon atoms of other organic groups.

The term “thiol” refers to —SH groups. In some cases, thiols are referred to as mercaptans

The term “vinyl” refers to the ethene group —CH═CH₂. It may be combined with other groups to provide larger groups such as vinyl ether (—R—O—CH═CH₂ where R is a hydrocarbon group, including but not limited to alkylene, alkenylene, arylene, and the like), vinyl ketone (—(C═O)—CH═CH₂), and the like.

In general, “substituted” refers to a group, as defined herein (e.g., an alkyl, alkenyl, alkylene, alkenylene, aryl, arylene, and the like), in which one or more hydrogen atoms contained therein are replaced one or more non-hydrogen or non-carbon atoms or to carbon atom(s) bearing one or more heteroatoms. Substituted groups also include groups in which one or more bonds to a carbon(s) hydrogen(s) atom are replaced by one or more bonds, including double and triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens; hydroxyls; alkoxy, alkenoxy, alkynoxy, aryloxy, aralkyloxy, aroyloxyalkyl, heterocyclyloxy, and heterocyclylalkoxy groups; carbonyls oxo), acyl; carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; thioamides; ureas; amidines; guanidines; enamines; imides; isocyanates; isothiocyanates; cyanates; thiocyanates; imines; nitro groups; nitrites; and the like. Such groups may be pendant or integral to the carbon chain itself. Cyclic groups (e.g., cycloalkyl, cycloalkenyl, and aryl) may also be substituted by carbon-based groups such as alkyl, alkenyl, and alkynyl, any of which may also be substituted (e.g., haloalkyl, hydroxyalkyl, aminoalkyl, haloalkenyl, and the like).

One aspect of the present technology relates to preservatives for cellulosic materials and articles including such materials and preservatives. The preservatives are polymers that include at least one disaccharide. The disaccharide may be of any type, including one having an antimicrobial activity. For example, provided in some embodiments is an article, which includes a cellulosic material and at least one polymer including at least one antimicrobial disaccharide. The preservative may be, thr example, impregnated into the cellulosic material. The preservative may be distributed uniformly throughout the cellulosic material. Alternatively, the preservative may be reside only at or in certain parts of the cellulosic material—e.g., on the surface, just below the surface or in a shallow region extending from the surface down into the cellulosic material to act as a barrier.

The cellulosic material may be any material that contains cellulose. For example, the material may include wood, paper, cardboard or a combination of any two or more thereof. The wood may be any type of wood, including pine, oak, maple, spruce, fir, birch, cherry, cedar, redwood, or any other type of wood. The wood may be natural, synthetic, or a combination of both, such as a hybrid structure. In some embodiments, the cellulosic material may be a part of a wooden plank, utility pole, railroad tie, ship's hull, wooden utensil, toy, model, piece of furniture, vehicle, serving dish, or a combination of any two or more thereof. The articles described (and the preservatives used therein) may be a component employed during a chemical synthesis or a component of organo-electronics, semiconductor, medicaments, lubrication, pyrotechnics, or anti-fouling coatings. The preservatives and the methods related thereto described herein may be applicable to any type of structure containing a material containing cellulose.

The polymers in the articles provided herein may be any suitable polymers for the variety of applications in which the articles may be employed. The polymers may be natural, synthetic (or non-natural), or a combination of both. In some embodiments, the polymers are non-natural polymers, such as, e.g., a polyolefin. Various polyolefins may be employed in the methods and the articles described herein. For example, the polyolefin may be one of polyacrylate, polymethacrylate, polyacrylamide, and polymethacrylamide or a copolymer of one or more thereof. Other polyolefins and types of polymers may also be used. For example, polyethylene, polypropylene, or a combination of both, may be used. In one embodiment, the polymer used may be a copolymer of polyethylene and/or polypropylene copolymerized with a polyacrylate or polyacrylamide.

Disaccharides provided herein are dimers of carbohydrate units. The disaccharides provided in some embodiments may have antimicrobial properties. For example, the disaccharides may be anti-bacterial, anti-fungal, or a combination thereof. The disaccharides provided herein may also be effective against the growth of other microorganisms in general. For example, the disaccharide may inhibit synthesis of peptidoglycan and/or cell walls, which may lead to lysis and/or cell death. See e.g., Baizman et al, Microbiology (2000), 146, 3129-3140. In some embodiments, because the disaccharides are antimicrobial, the polymer containing the disaccharides for the article containing the polymer may be antimicrobial (i.e., have antimicrobial properties).

The disaccharide may be derived from natural sources or may be synthetic, or a combination of both. For example, sophorose may be derived from agricultural products. Non-limiting examples of the disaccharides that may be employed in the embodiments herein may include any monomer or polymer that contains the groups of sophorose, maltose, sucrose, lactulose, lactose, maltose, trehalose, cellobiose, kojibiose, nigerose, gentiobiulose, maltulose, isomaltose, trehalose, sophorose, laminaribiose, gentiobiose, turanose, palatinose, mannbiose, melibiose, xylobiose, melibiulose, rutinose, rutinulose, galactofuranose, streptobiosamine, or a combination of any two or more thereof. While there is no limit on the type of disaccharide that may be used, in some occasional instances certain disaccharide is avoided due to the nature of application. In these instances, the disaccharide may be any of the aforementioned disaccharides or other disaccharides, including glycosides. The disaccharide may be directly attached to the polymer using standard synthetic techniques or may be polymerizable, i.e., capable of being polymerized to form a polymer bearing one or more disaccharides.

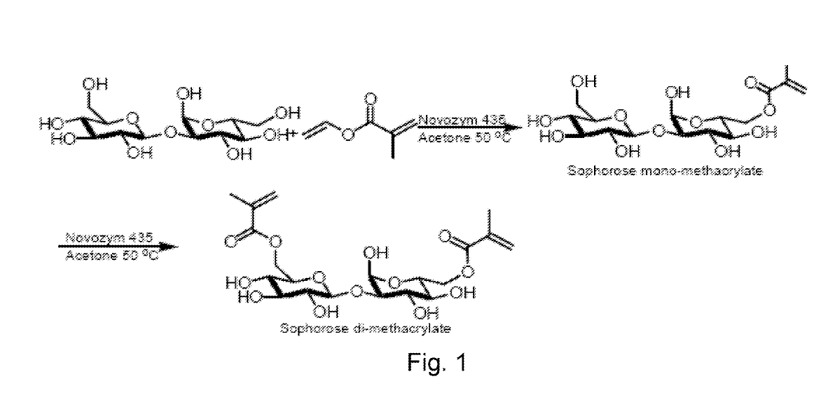

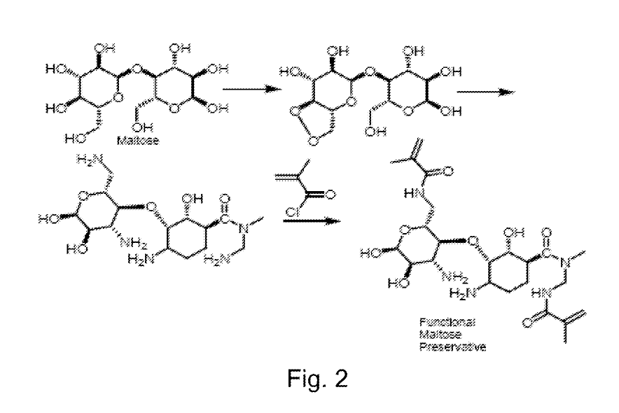

The disaccharides described herein may contain any moieties that may render them useful for the applications desired. In other words, the disaccharide may be functionalized to contain different moieties for different applications. For example, the primary alcohol of the disaccharide may be functionalized with moieties including acrylic, vinyl, styrenic, drying oil, or a combination of any two or more thereof. As further described below, these moieties may allow the wood preservative to be polymerized. In some embodiments, the disaccharides may contain one or more of an acrylate, methacrylate, acrylamide or methacrylamide moiety. Accordingly, the disaccharides described herein may contain any combination of any of the moieties aforedescribed. For example, the disaccharide may include a sophorose dimethacrylate, as shown in FIG. 1. Other examples of disaccharides are also possible. For example, maltose, or derivatives thereof, may be used. In one embodiment, the disaccharide may be an acrylamide disaccharide derived from maltose, as shown in FIG. 2. In some embodiments, the disaccharides employed may be those that form a network within the cellulosic material such that the disaccharide molecules do not leach out of the cellulosic material. The level of leaching out may be low. For example, only 25% of less of the disaccharide molecules would leach out during the use of the cellulosic material—e.g., 20% or less, 15%, 10%, 5%, 2%, 1%, or less. The percentage herein may refer to volume percentage or weight percentage, depending on the context.

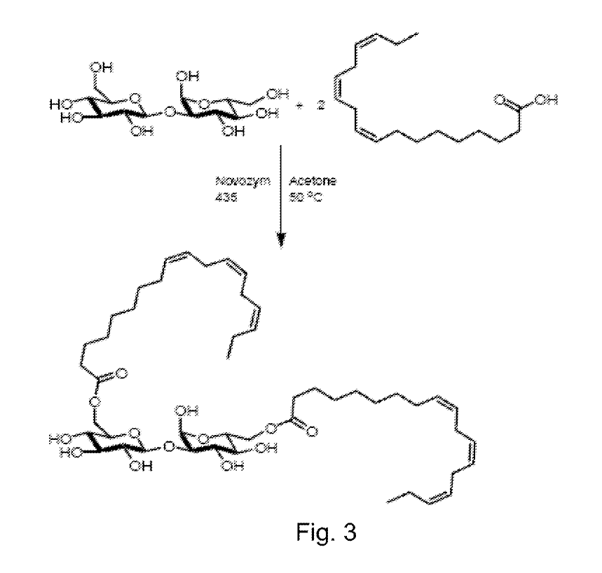

In some other embodiments, the polymer containing the disaccharide may contain a lipid moiety. The lipid moiety described herein may refer to any fatty acid moiety, glyceride moiety (including without limitation, mono-, di-, or triglyceride), phospholipid moiety, prenol lipid moiety, polyketide moiety, or a combination of any two or more thereof. The lipid moiety may be, for example, an omega-3 fatty acid moiety. Non-limiting examples of omega-3 fatty acids include oleic acid, linolenic acid, linoleic acid, and the like. FIG. 3 illustrates structures of sophorose preservative with fatty acid, wherein the fatty acid may be polymerized. In this embodiment, free acid can react with the sophorose substrate using enzyme mediated esterification.

Sophorose is a disaccharide carbohydrate sugar that exhibits anti-bacterial and antimicrobial properties. Its chemical structure allows for vinylic structures to be synthesized, thus creating a class of polymerizable preservatives that prevents unwanted leaching of the preservative into the environment. As described above, the sophorose structure can be tuned by placing lipid moieties onto the disaccharide, which affects the anti-microbial and anti bacterial properties of the molecule. Furthermore, more than one position on sophorose can be functionalized, thereby forming highly cross-linked structures. Sophorose compounds are stable. For example, one preservative containing sophorose described herein may be stable at very low pH (e.g., pH that is less than or equal to 5, 4, 3, 2, or 1) or very high pH (e.g., pH that is greater than or equal to 8, 9, 10, 11, 12, 13, or 14) conditions.

in some embodiments, the polymer may contain repeating units formed from a monomer of Formula I:

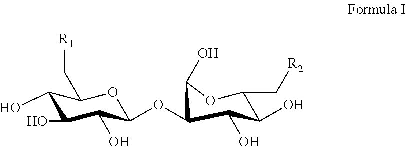

wherein: R₁, R₂ are each independently OH or a moiety that is acrylic, methacrylic, styrenyl, vinyl, vinyl thioether, vinyl ketone, vinyl ether, vinyl alcohol ester, vinyl amide, cyclobutenyl, cyclopentenyl, cyclohexyl, acrylamide, isocyanate, epoxy, oxetanyl, bicyclo[2.2.1]hept-2-enyl, DL-lactide, or a combination of any two or more thereof. In some embodiments, the repeating units may be formed from a mixture of mono- and di-acrylic or methacrylic monomers of Formula I. In one embodiment, the amount of mono- and di-methacrylates used may be controlled by tailoring the amount of vinyl methacrylate used. Other types of mixtures may be used to form the repeating units, depending on the applications desired.

In some embodiments, the article may include cross-linked structures of the monomers as described above. For example, the polymer may contain a cross-linked disaccharide polymer network, such as a sophorose polymer network.

In some embodiments the polymer may further contain a cross-linking moiety as a part of the network structure. In some embodiments, the cross-linking moiety may be linked to, for example, a disaccharide moiety; the disaccharide may be any of the disaccharides described above. Various cross-linking moieties exist and may be used depending on the chemistry of the molecules involved and the applications described. In some embodiments, the cross-linking moiety may include styrene, vinyl ketone, urethane, ester, ether, thioether, disulfide, divinyl benzene, ethyleneglycol dimethacrylate, polyethylene glycol dimethacrylate, pentaerythritol trimethacrylate, hexamethylene dimethacrylate, neopentyl glycol dimethacrylate, ethylene diamine, diethylene triamine, polyamide, mercaptans, or a combination of any two or more thereof.

In some embodiments, the cross-linking moiety may be linked to another moiety (e.g., disaccharide) through a spacer moiety, although the spacer is optional. Various spacer moieties exist and may be used depending on the chemistry of the molecules involved and the applications described. In some embodiments, the spacer may include a moiety selected from the group consisting of amine, alkylene, alkenylene, alkynylene, arylene, ether, polyether, ester, polyester, polyurea, polyurethane, lactam, polyamide, amide, thioether, phosphoryl, phosphorous, borate, boron, arsenic, haloalkylene, haloalkenylene, haloalkynylene, haloarylene and a combination of any two or more thereof. For example, the spacer may include methylene, ethylene, ethenylene, propylene, propenylene, butylene, butenylene, pentalene, pentenylene, hexalene, hexenylene, heptalene, heptenylene, octalene, octenylene, nonalene, nonenylene, decalene, decenylene, fluoroalkylene, fluoroalkenylene, fluoroalkynylene, fluoroarylene, chloroalkylene, chloroalkenylene, chloroalkynylene, chloroarylene, bromoalkylene, bromoalkenylene, bromoalkynyiene, bromoarylene, iodoalkenylene, iodoalkynylene, iodoarylene, or a combination of any two or more thereof.

In another aspect, methods of making and using the preservatives, thus to preserve a cellulosic material, are provided. In one embodiment, a method of preserving a cellulosic material may include contacting the cellulosic material with at least one polymer including at least one antimicrobial disaccharide. Different contacting mechanisms may be carried out to expose the cellulosic material (to be preserved) to the disaccharide-containing preservatives. For example the polymer may be incorporated into the cellulosic material as an ingredient during the fabrication process. Alternatively, the polymer may be injected into the cellulosic material by a mechanical force, such as by pressure. Depending on the materials involved, a variety of pressures may be suitable. For example, the pressure may be from about 50 atmospheres (atm) to about 500 atm—e.g., about 50 atm, about 100 atm, about 200 atm, about 300 atm, about 400 atm, about 500 atm or any range between and/or including two such pressures. The pressure may also be lower, but must be sufficiently high to force the polymer into the cellulosic material. Alternatively, a vacuum process, sometimes alternating with high pressure, may be used. In one embodiment involving a vacuum process, the solution containing the polymer is placed on one side of the cellulosic material and a vacuum is applied to the other side. As a result of the pressure differential, the vacuum pulls the polymer into (and through) the cellulosic material. A partial vacuum or high vacuum may be employed. In some embodiments, supercritical fluid rather than air or other gas may be utilized to facilitate the contacting process.

The preservation process may further include polymerizing monomers to form the aforedescribed polymer. The polymerization may be applied before or after the polymer is in contact with the cellulosic material. For example, the monomers of Formula I may be polymerized while the monomers are already in contact with the cellulosic material (i.e., after they are already in contact). For example, after the cellulosic material is exposed (e.g., by injection) to the disaccharide-containing monomer, the monomers may then form cross-linked networks. The network(s) may form a barrier to prevent unwanted leaching of cellulosic preservatives from the cellulosic material into the ambiance. In an alternative embodiment, the monomers of Formula I in this embodiment may be polymerized first before the polymers are brought into contact with the cellulosic material.

Due to the properties of the aforedescribed polymers, the preservatives in the articles described above may have several advantages over the conventional preservatives of cellulosic materials. For example, in the embodiment wherein the cellulosic material is wood, the preservatives described herein may exhibit desirable bonding capability with the wood due to the high compatibility between the preservative and the wood. Also, because the preservatives may be derived from natural sources, they may be environmentally benign and their degradation may also be environmentally benign,

### EXAMPLES

The present technology is further illustrated by the following examples, which should not be construed as limiting in any way.

### Example 1

### Fabrication of a Preservative

A preservative containing sophorose methacrylate is synthesized according to the process described below. FIG. 2 provides an illustration of this process in one embodiment.

A sophorose substrate (7.2062 g, 0.02 mol), vinyl methacrylate (10.7644 g, 0.096 mol), Candida Antarctica lipase immobilized polymer (Novozym 435, 4.03 g), and a few granules of BHT (to inhibit radical generation) are added to an Erlenmeyer flask containing 50 mL of acetone and sealed with a rubber septum. The flask is placed in a heated water stirring bath (50 C and 150 rpm) and allowed to react for 5 days. After 5 days, the yellow solution is filtered to remove the lipase enzyme from the monomer solution. Flash chromatography is performed (ethyl acetate:hexane:ethanol 7:2:1, Rf=0.38) on the crude residue to separate the desired monomer from any side reaction products. The relevant fractions are combined and rotary evaporation performed to remove solvent, which results in a pale yellow oil.

Using the method above both mono and di methacrylates can be produced, by controlling the amount of vinyl methacrylate used. The residue is dissolved in water for freeze-drying to yield the final, white powder product with a 70% yield.

### Example 2

### Activity of Preservative

Antimicrobial activity of preservatives of the present technology may be. In this test, malt extract agar plates are prepared, amended with various concentrations of the preservative of the present technology to be tested, along with additional petri dishes seeded with a known chemical system. Selected stain, mold and decay fungi is inoculated onto these plates and the plates are incubated until the fungi had overgrown plates with non-amended media. Radial growth is measured and used to assess efficacy of the preservative. Typically, 4 to 5 concentrations of each system is applied and is tested against 3 decay fungi (e.g., Postia placenta, Gloeophyllum trabeum, and Trametes versicolor), 1 stain fungus (Ophiostoma piceae), and two mold fungi (Aspergillus niger and a Penicillium spp.). Each fungus would be replicated on a minimum of 3 plates per treatment combination. This test provides an approximate range of activity for the preservative(s). The data produced is used to calculate a minimum inhibitory concentration using standard procedures. If needed, the test is then repeated with a narrower range of test concentrations in order to obtain a more accurate assessment of the minimum inhibitory concentration.

### Example 3

### Preserving Wood

Sophorose compounds are utilized as wood preservatives in this example. Many techniques may be employed to apply the preservatives to wood; one technique is to expose the wood products being preserved to the preservatives (sophorose compounds in this Example) under high pressure. The pressure process and variations of the pressure process are described below.

1. High Pressure Process.

The pressure may facilitate the impregnation of the sophorose compounds into the wood at the molecular level. The treatment of the wood is carried out in closed vessels where the wood is exposed to the sophorose compounds and then either pressure or vacuum is applied. The pressure is between 100 and 300 atm. In the case of vacuum, the vacuum is about 10⁻² torr.

A pressure process may have a number of advantages over a non-pressure process; the advantages include deeper and more uniform penetration and a higher absorption of preservative achieved than for a non-pressure process. Conditions under which the sophorose preservative is applied may be controlled so that retention and penetration may be varied. Also, a pressure process can be adapted to large-scale production. For example, the pressure treatment process may used to protect railroad ties, telephone poles, building members, and structural materials.

2. Full-Cell Process

A full-cell process is a variation of the pressure process. In the context of applying a (polymer) preservative into wood, the full-cell process is used to help the wood retain as much of the preservative as possible. In some instances, timbers may be treated with creosote using the full-cell process to protect the timbers from marine borers. Waterborne preservatives may also be applied by the full-cell process. Preservative retention can be controlled by regulating the concentration of the treating solution. In one instance, a full-cell process may include at least some of the following:

1. Wood is sealed in the treatment cylinder and a preliminary vacuum is applied for a period of time (e.g., at least half an hour—e.g., at least 1 hour, 2 hours, 3 hours, or more) to remove the air from the cylinder and as much air as possible from the wood.

2. The preservative is pumped into the cylinder without breaking the vacuum. The preservative may be at the ambient temperature or higher, depending on the system.

3. After the cylinder is filled, pressure is applied, until the wood is no longer able to accommodate any more preservative r or until a predetermined retention level of the preservative in the wood is achieved.

4. After pressure has been applied for the specified time, the preservative is pumped from the cylinder.

5. A short final vacuum may be used to remove excess preservative from the wood (e.g., the preservative r dripping from the wood).

In the full-cell process, it is important to keep as much of sophorose preservative absorbed into the wood during the pressure period as possible. Thus, the maximum concentration of sophorose preservatives is in the wood at all times. The desired retention of the preservatives is achieved by changing the strength of the solution.

3. Fluctuation Pressure Process

A fluctuation process is another variation of the pressure process. The fluctuation process is a “dynamic” process in that the conditions under which the preservative is applied are constantly changing. The pressure inside the preservative application cylinder changes between vacuum and high pressure within a few seconds in the fluctuation process. This process is used for woods that can split or otherwise fail under other pressure application procedures or due to the application procedures.

### Example 4

### Polymerization of Preservatives in Wood

In this example, once the sophorose wood preservative is within the wood structure, it is polymerized. This step locks the wood preservative into the wood structure so it will not be leached out.

The polymerization takes place though a chain growth mechanism via the methacrylate moieties on the disaccharide. The polymerization can be catalyzed though the use of driers; a variety of methods may be suitable for the polymerization. The resulting polymers can be complex in structure, and the result is a highly cross-linked polymer network.

In this example, solvent is dehydrated over molecular sieves 5 A in advance. The solvent used is acetone or acetonitrile, or both. Sophorose substrate (25 mmol), lauric acid (125 mmol), and the immobilized lipase (10 g) are placed in a dried reaction flask. To the flask 500 mL of the solvent (e.g., acetone or acetonitrile) is then added to dissolve or disperse the substrate. The flask is capped and then immersed in a thermoregulated water bath at 50° C.

After the sophorose-containing preservatives are injected via pressure into the wood and the wood grain is filled with the preservatives, the sophorose is allowed to polymerize in the wood grain. The polymerized sophorose forms a highly cross-linked sophorose polymer network, which forms a barrier in the wood.

### Example 5

### Protection of Preserved Wood

The protection provided to a wood article treated according to one of the methods of Example 2 herein may be tested using the following Soil Block Test Southern pine sapwood blocks are oven dried, impregnated with the test chemical (see Example 1, herein) at a given concentration; re-dried and then sterilized. The decay chambers are glass bottles half filled with soil. A wood feeder strip is placed on the soil surface and the jar is sterilized prior to be inoculated with a test fungus. Once the fungus has grown across the feeder, the test block is placed on the surface and the jar is incubated for 12 to 16 weeks at 28 C. Weight loss at the end of the test (as measured by oven-drying and weighing each block) is used as the measure of fungal efficacy. The results are then used to calculate a threshold for protection using any suitable procedure known in the art. It is sometimes also helpful to leach some blocks—the test blocks are treated as above, then subjected to a wet/dry cycle before being exposed to the test fungus. The three decay fungi listed above are tested, plus anon-sterile soil burial test (which evaluated resistance to bacterial and soft rot fungi) may be carried out.

The present technology, thus generally described, will be understood more readily by reference to the Examples, which are provided by way of illustration and are not intended to be limiting of the present technology.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed, herein are for purposes of illustration and are not intended to be limiting, with the true scope and spirit being indicated by the following claims.

1.-31. (canceled)

32. An article comprising a cellulosic material and at least one polymer comprising at least one antimicrobial disaccharide.

33. The article of claim 32, wherein the cellulosic material comprises wood, paper, or both.

34. The article of claim 32, wherein the article is a wooden plank, utility pole, railroad tie, ship's hull, wooden utensil, toy, model, piece of furniture, vehicle, or serving dish.

35. The article of claim 32, wherein the polymer is a polyolefin.

36. The article of claim 32, wherein the polymer is a polyolefin selected from the group consisting of polyacrylate, polymethacrylate, polyacrylamide, and polymethacrylamide.

37. The article of claim 32, wherein the antimicrobial disaccharide is selected from the group consisting of sophorose, maltose, sucrose, lactulose, lactose, maltose, trehalose, cellobiose, kojibiose, nigerose, gentiobiulose, maltulose, isomaltose, trehalose, sophorose, laminaribiose, gentiobiose, turanose, palatinose, mannbiose, melibiose, xylobiose, melibiulose, rutinose, rutinulose, galactofuranose, streptobiosamine, or a combination of any two or more thereof.

38. The article of claim 32, wherein the polymer comprises repeating units formed from a monomer of Formula I: 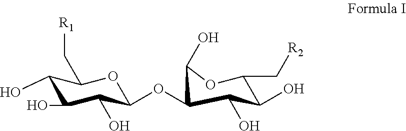
wherein:
R₁, R₂ are each independently OH or a moiety that is acrylic, methacrylic, styrenyl, vinyl, vinyl thioether, vinyl ketone, vinyl ether, vinyl alcohol ester, vinyl amine, vinyl amide, cyclobutenyl, cyclopentenyl, cyclohexyl, acrylamide, isocyanate, epoxy, oxetanyl, bicyclo[2.2.1]hept-2-enyl, DL-lactide, or a combination of any two or more thereof.

39. The article of claim 38, wherein the polymer comprises repeating units formed from a mixture of mono- and di-acrylic or methacrylic monomers of Formula I.

40. The article of claim 32, wherein the polymer further comprises a lipid moiety.

41. The method of claim 32, wherein the polymer further comprises an omega-3 fatty acid moiety.

42. The article of claim 32, wherein the antimicrobial disaccharide comprises a cross-linking moiety.

43. The article of claim 32, wherein the disaccharide comprises one or more of an acrylate, methacrylate, acrylamide or methacrylamide moiety.

44. A method of preserving a cellulosic material, the method comprising:
polymerizing a monomer of Formula I to make a polymer comprising repeat units formed from the monomer; and
contacting the cellulosic material with the polymer;
wherein the monomer of Formula I is 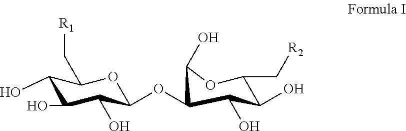
and
R₁, R₂ are each independently OH or a moiety that is acrylic, methacrylic, styrenyl, vinyl, vinyl thioether, vinyl ketone, vinyl ether, vinyl alcohol ester, vinyl amine, vinyl amide, cyclobutenyl, cyclopentenyl, cyclohexyl, acrylamide, isocyanate, epoxy, oxetanyl, bicyclo[2.2.1]hept-2-enyl, DL-lactide, or a combination of any two or more thereof.

45. A method of preserving a cellulosic material, the method comprising:
contacting the cellulosic material with at least one polymer comprising at least one antimicrobial disaccharide.

46. The method of claim 45, wherein the contacting step comprises polymerizing a plurality of monomers of Formula I, 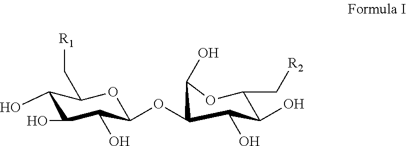
while the monomers are in contact with the cellulosic material, wherein
R₁, R₂ are each independently OH or a moiety that is acrylic, methacrylic, styrenyl, vinyl, vinyl thioether, vinyl ketone, vinyl ether, vinyl alcohol ester, vinyl amine, vinyl amide, cyclobutenyl, cyclopentenyl, cyclohexyl, acrylamide, isocyanate, epoxy, oxetanyl, bicyclo[2.2.1]hept-2-enyl, DL-lactide, or a combination of any two or more thereof.

47. The method of claim 45, wherein the polymer further comprises a lipid moiety.

48. The method of claim 45, wherein the polymer further comprises an omega-3 fatty acid moiety.

49. The method of claim 45, wherein the polymer further comprises a maltose moiety.

50. The method of claim 45, wherein the polymer further comprises a cross-linking moiety linked to the disaccharide moiety.

51. The method of claim 45, wherein the cellulose material comprises wood or paper.

52. An article comprising at least one non-natural polymer comprising at least one antimicrobial disaccharide comprising a cross-linking moiety.

53. An article comprising a cellulose material and the composition of claim 52, wherein the cellulose material comprises wood, paper, or both.

54. The article of claim 52, wherein the disaccharide is linked to the cross-linking moiety through at least one spacer.

55. The article of claim 52, wherein the cross-linking moiety comprises styrene, vinyl ketone, urethane, ester, ether, thioether, disulfide, divinyl benzene, ethyleneglycol dimethacrylate, polyethylene glycol dimethacrylate, pentaerythritol trimethacrylate, hexamethylene dimethacrylate, neopentyl glycol dimethacrylate, ethylene diamine, diethylene triamine, polyamide, mercaptans, or a combination of any two or more thereof.

56. The article of claim 52, wherein the spacer comprises a moiety selected from the group consisting of amine, alkylene, alkenylene, alkynylene, arylene, ether, polyether, ester, polyester, polyurea, polyurethane, lactam, polyamide, amide, thioether, phosphoryl, phosphorous, borate, boron, arsenic, haloalkylene, haloalkenylene, haloalkynylene, haloarylene and a combination of any two or more thereof.

57. The article of claim 56, wherein the spacer comprises methylene, ethylene, ethenylene, propylene, propenylene, butylene, butenylene, pentalene, pentenylene, hexylene, hexenylene, heptalene, heptenylene, octalene, octenylene, nonalene, nonenylene, decalene, decenylene, fluoroalkylene, fluoroalkenylene, fluoroalkynylene, fluoroarylene, chloroalkylene, chloroalkenylene, chloroalkynylene, chloroarylene, bromoalkylene, bromoalkenylene, bromoalkynylene, bromoarylene, iodoalkylene, iodoalkenylene, iodoalkynylene, iodoarylene, or a combination of any two or more thereof.
